(19) United States
(12) Patent Application Publication
(10) Pub. No.: US 2012/0292140 A1
(43) Pub. Date: Nov. 22, 2012

(54) ELECTRIC BRAKE

(75) Inventor: Michael Reich, Herford (DE)

(73) Assignee: HANNING & KAHL GMBH & CO. KG, Oerlinghausen (DE)

(21) Appl. No.: 13/574,638

(22) PCT Filed: Feb. 10, 2011
(86) PCT No.: PCT/DE2011/000126

§ 371 Date: Jul. 23, 2012

(30) Foreign Application Priority Data
Feb. 10, 2010 (DE) 10 2010 001 782.5
Jul. 26, 2010 (DE) 10 2010 038 418.6

(51) Int. Cl. F16D 65/18

(52) U.S. Cl. 188/72.3

(57) ABSTRACT

The invention relates to a brake, comprising at least one brake actuating element, which is operatively connected to a planetary-roller threaded unit and to an electrical drive in order to move the brake actuating element between a braking position and an axially offset non-braking position of the brake actuating element, wherein the planetary-roller threaded unit has a plurality of threaded roller elements distributed in the circumferential direction, the threaded roller elements being in threaded engagement with a spindle element connected in a rotationally fixed manner to the electrical drive and with a stationary housing, and wherein the threaded roller elements are rotatably arranged about the axes thereof, which are each arranged parallel to an axis of the spindle element, and about the axis of the spindle element, wherein the brake actuating element is coupled only to the spindle element.

This present invention relates to a brake, for instance a brake of the type suitable for use in wind-electric power plants, comprising at least one brake actuating element which is operatively connected to a planetary-roller threaded unit and an electrical drive in order to move the brake actuating element between a braking position and an axially offset non-braking position, wherein the planetary-roller threaded unit has a plurality of threaded roller elements distributed in the circumferential direction wherein the threaded roller elements are in threaded engagement with a spindle element connected in a rotationally fixed manner to the electrical drive on the one hand and to a stationary housing on the other hand, and wherein the threaded roller elements are rotatably arranged about the axis thereof and each arranged parallel to an axis of the spindle element as well as rotatable about the axis of the spindle element.

Prior known from WO 03/076818 A1 is a brake for wind-electric power plants wherein a brake actuating element (brake shoe) acting on a brake disk is coupled to an electrical drive for reciprocal movements. The electrical drive comprises an electric motor which is via a lever linked to a gear that transforms a swivel movement into an axial movement. The gear may be of spindle or ball spindle or planetary-roller type. It comprises an axially shiftable and non-rotatable spindle element disposed inside a housing on one end of which the brake actuating element is fitted. A drawback affecting said prior art brake is that due to swivel lever coupling between the electric motor and the spindle element there is a flux of forces of relatively low efficiency created. In addition, said brake is of relatively large overall size.

EP 1 837 555 A1 is disclosing a brake with a direct acting electrical actuator that directly transforms the rotational movement of an electrical drive into an axial movement of a body which moves a brake actuating element (brake shoe) acting on a brake disk reciprocally between a braking position and a non-braking position. Said body acting on the brake actuating element is in the form of a threaded roller element of a planetary-roller threaded unit which is in threaded engagement with a spindle type rotor shaft of the electric motor on the one hand and with a stationary annular housing on the other hand. The threaded roller elements are arranged to swivel about their own axes. The axis of the threaded roller elements extends parallel to an axis of the spindle element. This prior known brake permits forces to be direct applied to the brake actuating element while at the same time reducing space demand. A drawback affecting that prior art brake however resides in the fact that the flux of forces is direct from the threaded roller elements to the brake actuating element via two axial bearings which must be designed with utmost precision to ensure synchronous reciprocal movements of the brake actuating element. In addition, a bellows is needed for centered positioning of the brake actuating element.

It is an object of this present invention to improve a brake in such a way that with but little effort involved it is possible to generate relatively high pressure forces while at the same time ensuring a relatively high efficiency and a small overall size.

To achieve this object the invention is in conjunction with the preamble of Patent Claim 1 characterized by the fact that the brake actuating element is coupled to the spindle element only.

The particular advantage of this invention is that relatively high pressure forces are transferred to a brake actuating element by means of a planetary-roller threaded unit while at the same time providing high efficiency. The introduction of forces is simple and reliable with the flux of forces taking place from a spindle element non-rotatably coupled to the electrical drive to the brake actuating element. The threaded roller elements of the planetary-roller threaded unit only serve for the transfer rather than the application of forces. The planetary-roller threaded unit is capable of generating relatively high compressive and tractive forces. The electrical drive has a relatively small gear reduction to thereby reduce space and cost.

A preferred embodiment of this invention provides for the brake actuating element to be connected to the spindle element via an axial bearing. This affords the advantage that the structural measures for the introduction of forces can be reduced. There is just one axial bearing and/or bearing unit needed along the force transmission path such that the costs for manufacture and maintenance may be kept down.

A modification of this present invention provides for the spindle element to be bell-shaped with a bottom and a hollow cylinder section protruding therefrom wherein a part at least of the electrical drive is arranged in said hollow cylinder section. It is an advantage, therefore, that for specific applications it is possible to couple electrical drives of different designs to the spindle element and/or to the planetary-roller threaded unit.

According to another modification of the invention it is possible for specific applications to have an electric motor or an electric motor/gear unit disposed inside the cavity of the spindle element. The design of the electrical drive may hence be variably adapted to the operational requirements of the brake without there being need to modify the basic design of the brake.

According to an alternative embodiment of the invention can the electrical drive be arranged outside the housing in which case it may be coupled to the spindle element via a toothed-wheel gear. This offers the advantage that the electrical drive can be designed with no particular consideration given to the dimensions of the spindle element.

Another modification of this invention provides for a plurality of threaded roller elements to be preferably arranged in an annular cage with recesses for threaded engagement of the threaded roller elements thereinto. Preferably the threaded roller elements are freely movable in axial direction. The cage provides improved guidance to the threaded roller elements in a gap between an outside of the spindle element and an inside of the housing.

According to a further modification of this invention the electrical drive and/or the spindle element is fixed to a hood which by a longitudinal wall axially extends on the outside of the housing. The advantage afforded by this arrangement resides in that the spindle element and/or the brake actuating element are center arranged.

A still further modification of the invention provides for the hood and/or the housing to be provided with detecting means to detect the axial position of the hood relative to the housing in an axial and/or circumferential relation. This affords the advantage that a torque and/or position dependent, for instance load dependent cutout of the electric motor can be achieved. Detecting means may for instance be used to detect wear of the brake actuating element such that an appropriate signal may be emitted that the brake actuating element needs to be exchanged or the pressure force acting on said element to be increased. Said detecting means should preferably be disposed in a plane in which the main force is generated so that detection may be achieved in the absence of canting errors.

According to another modification the detecting means used are limit switches and cams and/or spring elements coacting therewith. This affords the advantage that the brake can be cut out as a function of a swivel movement of the spindle element about its axis and/or as a function of its axial movement.

Exemplary embodiments of the invention will now described in closer detail with reference to the drawings.

### IN THESE DRAWINGS

FIG. 1 is a radial section through a brake of a first embodiment of the invention in a non-braking position;

FIG. 2 is a radial section through the brake of FIG. 1 which is in a braking position;

FIG. 3 is an axial section through the brake of FIG. 1 in the area of a planetary-roller threaded unit;

FIG. 4 is a radial section through a brake of a second embodiment of the invention which is in a braking position;

FIG. 5 is a radial section through a brake of a third embodiment of the invention which is in a braking position; and

FIG. 6 is a radial section through a brake of a fourth embodiment of the invention which is in a braking position.

A brake 1 of this present invention can preferably be used to brake down the propellers of wind generators in wind-electric power plants. Alternatively such a brake 1 may be employed also in braking assemblies of solar cell follow-up systems or in braking systems in the mechanical or medical technology field.

The brake 1 substantially comprises a brake actuating element 2 (brake shoe), a planetary-roller threaded unit 3 coupled to said brake actuating element 2 and an electrical drive 4 coupled to said planetary-roller threaded unit 3.

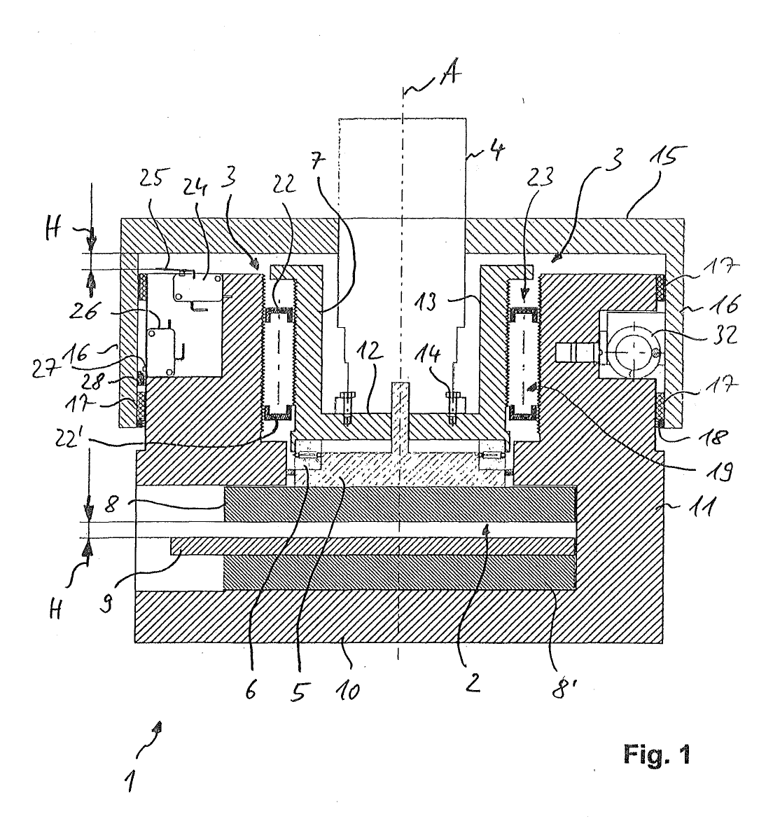

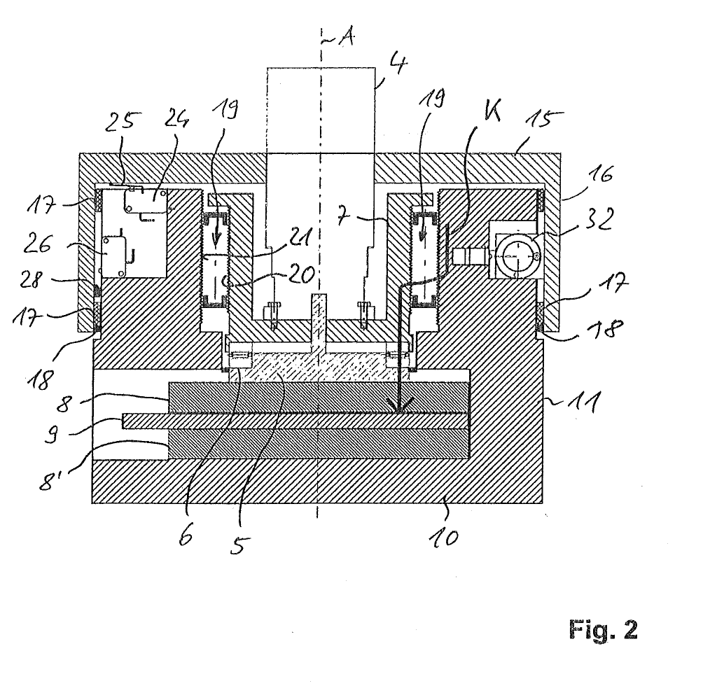

The brake actuating element 2 has on the one hand a holding disk 5 which is coupled to a bell-shaped spindle element 7 via a needle type axial bearing 6, and on the other hand a brake lining 8 on a side of the holding disk 5 that is facing away from the spindle element 7 which lining is moved into a pressure contact position with a brake disk 9 when the brake is actuated, i.e. when the brake actuating element 2 is axially shifted from a non-braking position according to FIG. 1 to a braking position according to FIG. 2. On a side of the brake disk 9 that is facing away from the brake actuating element 2 there is another brake lining 8′ arranged which is fixed to a foot 10 of a stationary housing 11 that encloses the spindle element 7. The housing 11 is of annular shape and has outer and/or inner shell walls extending cylindrically in part at least. Said foot 10 and/or said annular housing 11 is hence forming a caliper.

The bell-shaped spindle element 7 comprises a radially extending bottom 12 and a hollow cylinder section 13 protruding from said bottom 12 on a side thereof that is facing away from the brake actuating element 2. The electrical drive 4 is at least in part disposed inside this hollow cylinder section 13. The electrical drive 4 may be just an electric motor whose drive shaft is fixedly connected to the spindle element 7 and/or to the holding disk 5. Alternatively may the electrical drive 4 consist of an electric motor and a toothed wheel gear coupled thereto in which case said toothed wheel gear is arranged between the electric motor and the bottom of the spindle element 7. A toothed wheel of the gear on the output side thereof is fixedly connected to the spindle element 7 and/or to the holding disk 5. The toothed wheel gear is preferably of planetary type and completely enclosed by hollow cylinder section 13 of the spindle element 7. The electric motor is preferably in part disposed inside said hollow cylindrical section 13.

FIGS. 1 and 2 show that the electrical drive 4 is flanged to the bottom 12 of the spindle element 7 by means of bolts 14.

The electrical drive 4 is fixed to a hood 15 which surrounds the annular housing 11 by a cylindrical longitudinal wall 16 at the level of the planetary-roller threaded unit 3. Guide means 17 arranged on the outside of the annular housing 11 afford guiding action to the hood 15 relative to the annular housing 11 in axial direction. This implies that the hood 15 is both axially and circumferentially guided by said guide means 17. An annular seal 18 is provided at the free end of longitudinal wall 16 between said latter and the annular housing 11.

The planetary-roller threaded unit 3 comprises in addition to the spindle element 7 with a male thread on the hollow cylinder section 13 a plurality of threaded roller elements 19 which are distributed in circumferential direction and which substantially extend in an annular gap between an outer wall 20 of the hollow cylinder section 13 and an inner wall 21 of the annular housing 11. The threaded roller elements 19 are solid and of cylindrical shape and each extend between radial confining wall members 22, 22′ of an integral annular cage 23. Said confining wall members 22, 22′ of cage 23 are each provided with openings for the free ends of the threaded roller elements 19 to be supported in. The threaded roller elements 19 which each preferably extend between said confining walls 22, 22′ are provided with a male thread for threaded engagement with the outer wall 20 of the hollow cylinder section 13 of the spindle element 7 and with the inner wall 21 of the annular housing 11. Said threaded roller elements 19 are rotatable about their own axis on the one hand and about an axis A of the spindle element 7 on the other hand. Since the spindle element 7 is fixedly or non-rotatably connected to a drive shaft of the electrical drive 4 the spindle element 7 and the threaded roller elements 19 are caused to rotate whenever the electrical drive 4 is actuated. It is due to said threaded engagement of the threaded roller elements 19 with the stationary annular housing 11 that the rotational movement of the spindle element 7 is superimposed by an axial movement thereof such that the spindle element 7 can be axially moved from a non-braking position according to FIG. 1 to the braking position shown in FIG. 2 in which latter position the brake linings 8, 8′ act on the brake disk 9 with a predetermined pressure force.

Sections of the housing 11 are circular at least in the area of the threaded roller elements 19.

FIG. 2 shows a flux of forces between the annular housing 11 and the brake disk 9 which is denoted by an arrow K. It can be seen that said flux of forces acts on the brake actuating element 2 via the spindle element 7 and the axial bearing 6. The outer wall 20 of the hollow cylinder section 13, the inner wall 21 of the annular housing 11 and the threaded roller elements 19 have such thread pitches that the brake actuating element 2 is moved from a non-braking position to a braking position and vice-versa in response to a predetermined stroke H.

It can be seen that the electrical drive 4 is coaxial with the spindle element 7 and at least partly disposed inside the hollow cylinder section 13 of the spindle element 7 such that the structural unit consisting of planetary-roller threaded unit 3 and electrical drive 4 is of compact design.

The hood 15 and/or the annular housing 11 are provided with detecting means to detect the position of the spindle element 7 relative to the annular housing 11 in axial direction. To detect the axial position of the hood 15 in the braking position as per FIG. 2 the annular housing 11 has on a marginal edge facing the hood 15 a limit switch 24 which may be a microswitch. This limit switch 24 initiates a cutout of the electrical drive 4 and/or blocking thereof in braking position whenever the hood 15 reaches a contact flag 25 of the limit switch 24 by its radial surface.

The annular housing 11 moreover comprises another limit switch 26 on a circumferential edge whose contact pin 27 coacts with a cam 28 disposed on the inside of the longitudinal wall 16 of the hood 15 in such a way that the non-braking position, i.e. the expanded state of the spindle element 7 relative to the annular housing 11, may be recognized. The electrical drive 4 is cut out as said limit switch 26 is tripped.

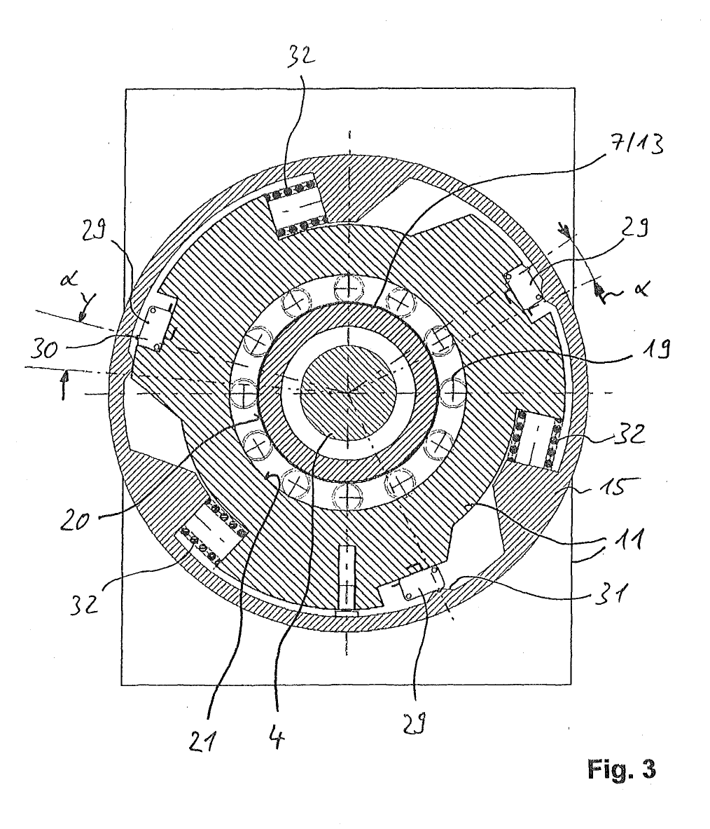

Additional limit switches 29 to serve as detecting means for force-dependent cutout of the electrical drive 4 are distributed over the outer circumference of the annular housing 11. Contact pins 30 of said limit switches 29 coact with axially extending cam strips 31 or cam points disposed on an inside of the longitudinal wall 16. FIG. 3 also shows that the hood 11 is circumferentially backed up relative to the annular housing 11 by spring elements 32. Since the limit switches 29 are disposed in a recess on the outer circumference of the annular housing 11 they are easily accessible from the outside for easy adjustment. Said limit switches 29 trip when the spindle element 7 and/or the hood 15 has been turned about the longitudinal axis A under a predetermined angle □ to thereby cut out the electrical drive 4 as a function of a particular swivel angle.

This implies that the detecting means as described ensure a cutout of the spindle element 7 dependent on its rotational and/or longitudinal position. In particular can a preadjustment and/or readjustment be easily achieved in case of wear of the brake lining 8, 8′.

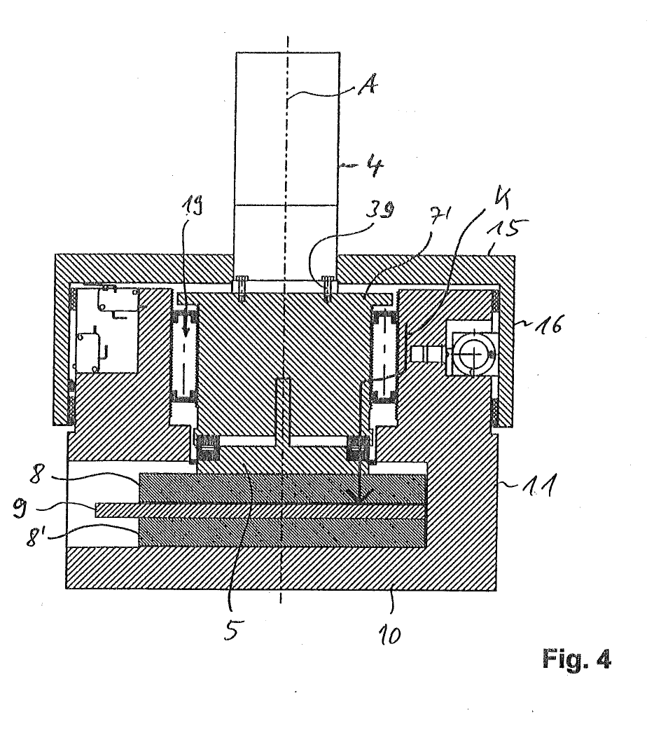

Further embodiments of this present invention as per FIGS. 4 to 6 provide for the electrical drive 4 to be arranged outside the housing (annular housing 11) also.

According to the embodiment as per FIG. 4 of this present invention the electrical drive 4 is connected to a solid spindle element 7′ by bolting. The electrical drive 4 is coaxial with said spindle element 7′. A central bore is provided in the hood 15 for fixing the electrical drive 4 to said solid spindle element 7′.

Identical components and/or component functions are denoted by identical reference signs.

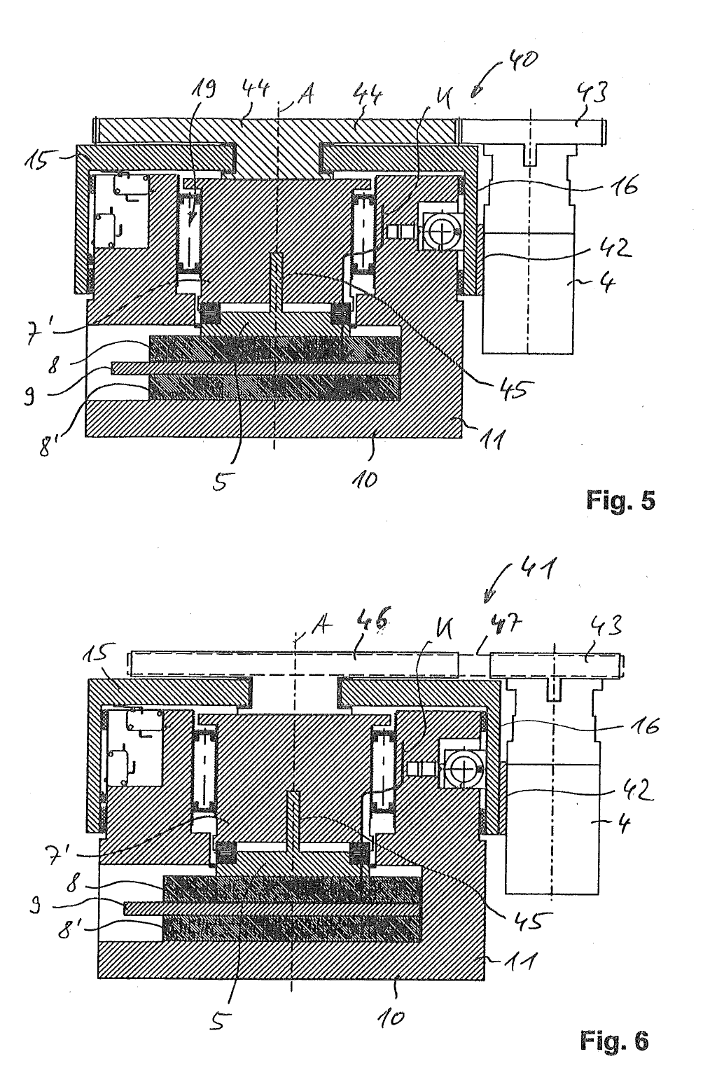

Another embodiment of this invention as per FIG. 5 provides for the electrical drive 4 to be coupled to the spindle element 7′ by means of a toothed-wheel gear. The drive 4 is parallelly offset from the spindle element 7′ and seated against the longitudinal wall 16 of the hood 15 by a supporting element 42. Same as in case of the other exemplary embodiments is the electrical drive 4 consisting of an electric motor and a gear which latter is coupled to a pinion 43 of the toothed-wheel gear unit. The pinion 43 is in engagement with a toothed wheel 44 which is coaxial with the spindle element 7′ and which is fixedly connected to a face end of the spindle element 7′ that is facing away from the holding disk 5. Same as in the previous embodiment is the spindle element 7′ fixedly coupled to a pin 45 that is integral with the holding disk 5. The toothed wheel 44 has a hub by means of which it is fixed to the hood 15. Said toothed wheel 44 may be non-positively or positively connected to the hood 15.

According to another embodiment of this present invention as per FIG. 6 can the electrical drive 4 be coupled to a toothed wheel 46 coaxial with the spindle element 7′ via a toothed-wheel gear or belt gear or a chain gear rather than direct via the pinion 43. An open type belt gear 41 is provided in this exemplary embodiment wherein a belt 47 is wrapped around the pinion 43 on the one hand and a belt pulley 46 coaxial with the spindle element 7′ on the other hand.

The exemplary embodiments hereinbefore described of the invention are not to be regarded as a definite and complete enumeration, but rather as examples for easy comprehension of the invention. For instance can the previously mentioned features be adopted in combination also.

1. A brake with at least one brake actuating element which is operatively connected to a planetary-roller threaded unit and an electrical drive in order to move the brake actuating element between a braking position and an axially offset non-braking position, wherein the planetary-roller threaded unit has a plurality of threaded roller elements distributed over its circumference, wherein the threaded roller elements are in threaded engagement with a spindle element that is connected the electrical drive in a rotationally fixed manner on the one hand and to a stationary housing on the other hand, and wherein the threaded roller elements are arranged to rotate about the axes thereof and are each arranged parallel to an axis of the spindle element, and wherein the brake actuating element (2) is coupled to the spindle element (7, 7′).

2. The brake according to claim 1, wherein the spindle element (7, 7′) at least is arranged to be axially movable relative to the housing (11) by means of the planetary-roller threaded unit (3).

3. The brake according to claim 1, wherein the transmission of forces from the electrical drive (4) to the brake actuating element (2) is accomplished via the spindle element (7, 7′).

4. The brake according to claim 1, wherein the spindle element (7, 7′) is fixedly connected to the electrical drive (4) and that the electrical drive (4) is axially and circumferentially guided relative to the housing (11).

5. The brake according to claim 1, wherein the brake actuating element (2) is connected to the spindle element (7) via an axial bearing (6).

6. The brake according to claim 1, wherein the spindle element (7) is bell-shaped with a bottom (12) and a hollow cylinder section (13) protruding from said bottom (12) on a side facing way from the brake actuating element (2) to receive a part at least of the electrical drive (4) and that the electrical drive is coaxial with the spindle element.

7. The brake according to claim 6, wherein the electrical drive (4) comprises an electric motor with a drive shaft wherein the drive shaft is fixedly connected to the spindle element (7) and wherein the electric motor is disposed inside the hollow cylinder section (13) either wholly or in part, or that the electrical drive (4) includes an electric motor and a toothed-wheel gear coupled thereto, wherein an output toothed wheel of the gear is fixedly connected to the spindle element (7) and wherein the toothed-wheel gear at least is arranged inside the hollow cylinder section (13) of the spindle element (7) either wholly or in part.

8. The brake according to claim 1, wherein the electrical drive (4) is arranged outside the housing (11) wherein said electrical drive (4) is fixedly connected to the spindle element (7′) on a side thereof that is facing away from the holding disk (5) or wherein the electrical drive (4) is coupled to the spindle element (7′) via a toothed-wheel gear (40) or an open type belt gear (41) or a chain gear.

9. The brake according to claim 8, wherein the electrical drive (4) is parallelly offset from the spindle element (7′) and that the electrical drive (4) is seated against the hood (15).

10. The brake according to claim 1, wherein the threaded roller elements (19) are circumferentially grouped together in an annular cage (23).

11. The brake according to claim 1, wherein the electrical drive (4) and/or the spindle element (7, 7′) is firmly attached to a hood (15) which is axially guided along the outside of the housing (11) by a longitudinal wall (16) with the aid of guide means (17).

12. The brake in particular according to claim 1, wherein the hood (15) and/or the housing (11) is provided with detecting means (24, 25, 26, 27, 28, 29, 30, 31) to detect the position of the hood (15) and/or the spindle element (7) relative to the housing (11) in axial and/or circumferential direction.

13. The brake according to claim 12, wherein the detecting means are limit switches (24, 26, 29) arranged on a peripheral edge of the housing (11) that is facing the hood (15) to coact with cams (28, 31) disposed on the inside of the longitudinal wall (16) of the hood (15) and/or with a radial wall of said hood (15).

14. The brake according to claim 12, wherein the hood (15) is backed up against the housing (11) by at least one spring element (32).
